(19) United States
(12) Patent Application Publication
(10) Pub. No.: US 2024/0289660 A1
(43) Pub. Date: Aug. 29, 2024

(54) SPECIAL PURPOSE QUANTUM RESOURCES INTEGRATION

(71) Applicant: SAP SE, Walldorf (DE)

(72) Inventors: Alexander OCHER, San Jose, CA (US); Viktor LAPITSKI, Mountain View, CA (US); Andre BELYY, Sunnyvale, CA (US)

(21) Appl. No.: 18/115,231

(22) Filed: Feb. 28, 2023

(51) Int. Cl. G06N 10/20

(52) U.S. Cl. CPC G06N 10/20

(57) ABSTRACT

Disclosed herein are system, method, and computer program product embodiments for providing integration of SPQRs. An embodiment operates by determining a first quantum operation associated with a first SPQR, and determining a second quantum operation associated with a second SPQR, the first quantum operation is different from the second quantum operation. The embodiment then receives a request to perform the first quantum operation using the first SPQR and the second operation using the second SPQR, causes the first SPQR to perform the first quantum operation, receives a first response from the first SPQR, transmits the first response to the second SPQR, and causes the second SPQR to perform the second quantum operation. The embodiment then receives a second response from the second SPQR.

### BACKGROUND

Quantum computing solutions, including quantum and/or quantum-inspired solutions, can potentially solve problems that are considered intractable on even the fastest classical computers. Quantum computing solutions use a fundamentally different paradigm for performing calculations and solving problems compared with standard classical computers. For example, the speed-up may be achieved using quantum physics to explore correlations in problems such that the correct answer emerges at the end of a computation through constructive interference.

A Special Purpose Quantum Resource (SPQR) may include, for example, a quantum computer with a quantum hardware or a quantum-inspired device with specialized hardware to perform a task in a different type or class that depends on the hardware. A SPQR of one type or class often cannot perform tasks, at least reasonably well, that a SPQR of another type or class can.

However, it can be challenging and difficult to combine the capabilities of multiple SPQRs, such as two or more SPQRs of different types, while providing a seamless integration of the multiple SPQRs.

### BRIEF DESCRIPTION OF THE DRAWINGS

The accompanying drawings are incorporated herein and form a part of the specification.

FIG. 1 illustrates an example system implementing mechanisms for providing integration of SPQRs, according to some embodiments of the disclosure.

FIG. 2 illustrates a block diagram of an example data processing system, according to some embodiments.

FIG. 3 illustrates a block diagram of an example SPQR, according to some embodiments.

FIG. 4 illustrates an example method for providing integration of SPQRs, according to some embodiments.

FIG. 5 illustrates an example computer system that can be used for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing integration of SPQRs.

Quantum computing solutions, including quantum and/or quantum-inspired solutions, can use different approaches, such as including, quantum computing with quantum hardware, and/or quantum-inspired computing with special-purpose hardware.

Quantum computing solutions may include a SPQR. In some aspects, a SPQR may include a quantum computer with a quantum hardware and/or a quantum-inspired computing device with a specialized hardware. A SPQR may only operate for a specific class of task. In some aspects, the quantum computer with the quantum hardware may include a quantum processer based on a Noisy Intermediate Scale Quantum (NISQ) architecture or a quantum annealing system. In some aspects, the quantum-inspired device with the specialized hardware may include, for example, a Quantum Annealer,

In some aspects, each SPQR may perform a task in a different type or class that depend on the hardware. Thus, a SPQR of one type or class often may not perform tasks, at least reasonably well, that a SPQR of another type or class can. Thus, it may be difficult to combine the capabilities of multiple SPQRs, such as two or more SPQRs of different types, while providing a seamless integration of the multiple SPQRs.

In some aspects, different types of two or more SPQRs may include or based on a difference in quantum computer architectures, and/or mathematics and physics associated with quantum principles associated with each SPQR. SPQR may use quantum principles, such, for example, quantum superposition and quantum entanglement, to process data in a way that is not possible for a conventional or classic computer. In one example, different quantum computer architectures may be best suited for different and/or specific tasks. For example, annealing systems (e.g., quantum annealing systems and quantum-inspired annealing systems) may solve only a limited class of problems because of the associated architectures. Quantum-inspired annealing systems may include a Digital Annealer and/or a Quantum Processing Unit (QPU). Annealing systems can be used to improve certain kinds of optimization algorithms, but may not be a general-purpose computing tool. In another example, a NISQ computer may be crippled by errors in the form of noise, faults and loss of quantum coherence, which is crucial to their operation, and as a result falls apart before any nontrivial program has a chance to run to completion.

In some aspects, there is a need to combine the different capabilities of multiple SPQRs, such as two or more SPQRs of different types, to perform a task. In one example, different capabilities of multiple SPQRs may be combined to solve a combinatorial optimization problem. For example, a Digital Annealer may use a Quantum-inspired Hierarchical Risk Parity (QHRP) portfolio optimization method to compose a risk-resistant portfolio and then securely send the resulting model using encryption keys generated by a NISQ computer. In one example, a NISQ computer may not optimize portfolios and/or perform any other commercially-useful operation other than random number generation. Alternatively or in addition, a Digital Annealer may not produce quantum encryption keys because it is not a true quantum computer. However, it may be difficult to provide a seamless integration of these multiple SPQRs.

Therefore, a technological solution is needed to provide integration of SPQRs, such as to use different capabilities of each SPQR in a same task.

The technological solution in the present disclosure can provide integration of SPQRs. Integration of SPQRs may include a process of data processing and/or control a processing chain of operations that are performed on multiple SPQRs. Integration of SPQRs may group SPQRs in a pipeline and/or chain processing for a task. Integration of SPQRs may provide a seamless integration of multiple SPQRs. In some examples, a first SPQR may perform a first class or type of task. A second SPQR may perform a second class or type of task, based on the output of the first SPQR. The output of the first SPQR and/or the second SPQR may be sent to a third SPQR and/or a classic computing system.

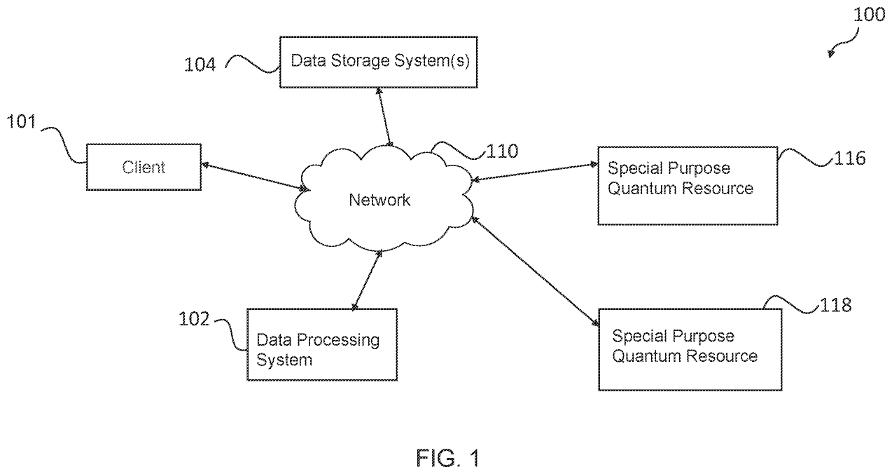

FIG. 1 illustrates an example system 100 implementing mechanisms for providing integration of SPQRs, according to some embodiments of the disclosure. The example system 100 is provided for the purpose of illustration only and does not limit the disclosed embodiments. The example system 100 may include, but is not limited to, a client device 101, a data processing system 102, one or more data storage systems 104, a network 110, a SPQR 116, and a SPQR 118.

In some aspects, each of SPQR 116 and SPQR 118 may include a quantum computer with a quantum hardware or a quantum-inspired device with a specialized hardware. In some aspects, each of SPQR 116 and SPQR 118 may include or may be a SPQR, to perform a task in a different type or class that depend on the hardware. SPQR 116 may be or may include a different type of SPQR, compared with SPQR 118. SPQR 116 and SPQR 118 may include a difference in quantum computer architectures, and/or mathematics and physics associated with quantum principles associated with each SPQR. In some examples, SPQR 116 may not perform a type of task that SPQR 118 may perform. The tasks or operations that SPQR 116 can perform may be incompatible with SPQR 118. Alternatively or in addition, the tasks or operations that SPQR 118 can perform may be incompatible with SPQR 116.

For example, SPQR 116 may include a Digital Annealer. SPQR 118 may include a NISQ computer. In one example, a Digital Annealer may be used to improve certain kinds of optimization algorithms, such as to use a QHRP portfolio optimization method to compose a risk-resistant portfolio. In another example, a NISQ computer may not optimize portfolios and/or perform any other commercially-useful operation other than random number generation.

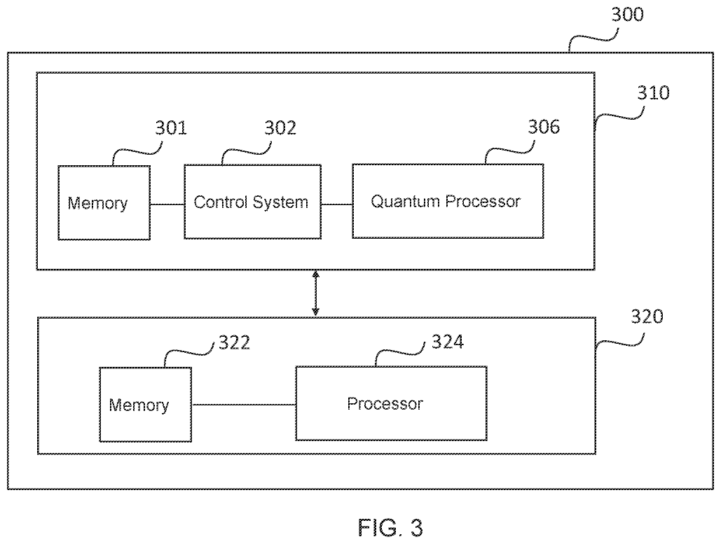

In some examples, each of SPQR 116 and SPQR 118 may include a quantum gate system or an Ising machine system. A quantum gate system may perform computation using quantum gates and quantum bits that can be in a superposition of 0 and 1 states. An Ising machine system may map a problem to a mathematical model of interacting magnets. In some examples, each of SPQR 116 and SPQR 118 may be based on a quantum architecture and/or a non-quantum architecture. Each of SPQR 116 and SPQR 118 may be implemented using combinations or sub-combinations of SPQR 300, as described in FIG. 3.

In some aspects, one or more data storage systems 104 may include, but is not limited to, databases, data files, data sources, and the like. Data processing system 102 may connect with one or more data storage systems 104 via network 110. Alternatively or in addition, data processing system 102 may connect to one or more data storage systems 104 via direct connections including, but not limited to, wired connections, internal connections, bus connections, virtual connections or other types of connections. In some aspects, data processing system 102 can also connect with additional data storage systems that are not shown in FIG. 1.

In some aspects, data processing system 102 may connect with of SPQR 116 and/or SPQR 118 via network 110. Alternatively or in addition, data processing system 102 may connect to SPQR 116 and/or SPQR 118 via direct connections including, but not limited to, wired connections, internal connections, bus connections, virtual connections or other types of connections. In some aspects, data processing system 102 may connect to SPQR 116 and/or SPQR 118 via one or more quantum commination connection, such as, but not limited to, an optical communication connection and/or a satellite communication connection. In some aspects, data processing system 102 can also connect with one or more SPQRs and/or one or more classic computing systems that are not shown in FIG. 1. In some aspects, data processing system 102 may be integrated with one or more SPQRs to form a hybrid system.

In some aspects, data processing system 102 may be implemented by one or more computer systems (e.g., servers), virtual machines operating on a computer system, or a combination thereof. Data processing system 102 may retrieve data from one or more data storage systems 104, SPQR 116 and/or SPQR 118. Data processing system 102 may process the retrieved data. Data processing system 102 may retrieve metadata associated with one or more quantum operations from SPQR 116 and/or SPQR 118. Based on the retrieved data from one or more data storage systems 104, data processing system 102 may send a request to perform operations, and/or receive a response to the request, from SPQR 116 and/or SPQR 118. The request to perform operations may be initiated by a client device, such as client device 101.

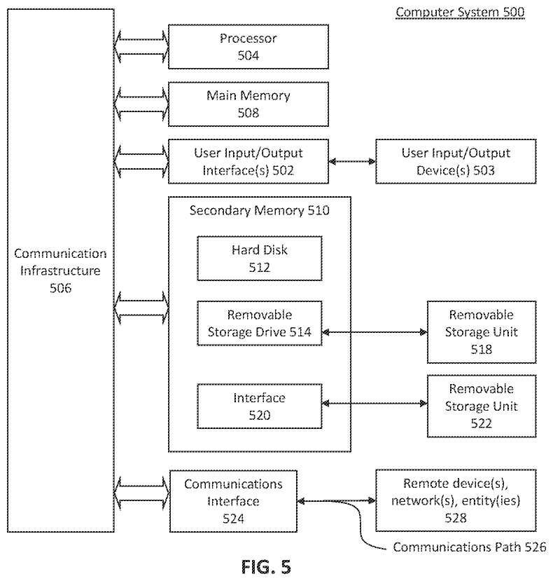

In some aspects, client device 101 may be configured to execute and operate a client application (e.g., a web browser, a proprietary client application, etc.) that communicates with the data processing system 102 via the network 110. This way, client device 101 may access the various functionalities provided by data processing system 102. Client device 101 may be the computer system 500 (see FIG. 5). Although the system 100 is shown with one client device, as would be appreciated by a person of ordinary skill in the art any number of client devices may be supported.

In some aspects, network 110 may be any type of network configured to facilitate data communications among client device 101, data processing system 102, one or more data storage systems 104, SPQR 116, and SPQR 118 using any of a variety of network protocols. Network 110 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc. Network 110 may include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof. Alternatively or in addition, network 110 may include a quantum communication network including for example, an integrated quantum communication network. In some aspects, the quantum communication network may include an optical communication network and/or a satellite communication network. In some aspects, the quantum communication network may be based on quantum key distribution (QKD), which uses the quantum states of particles (e.g., photons) to form a string of zeros and ones.

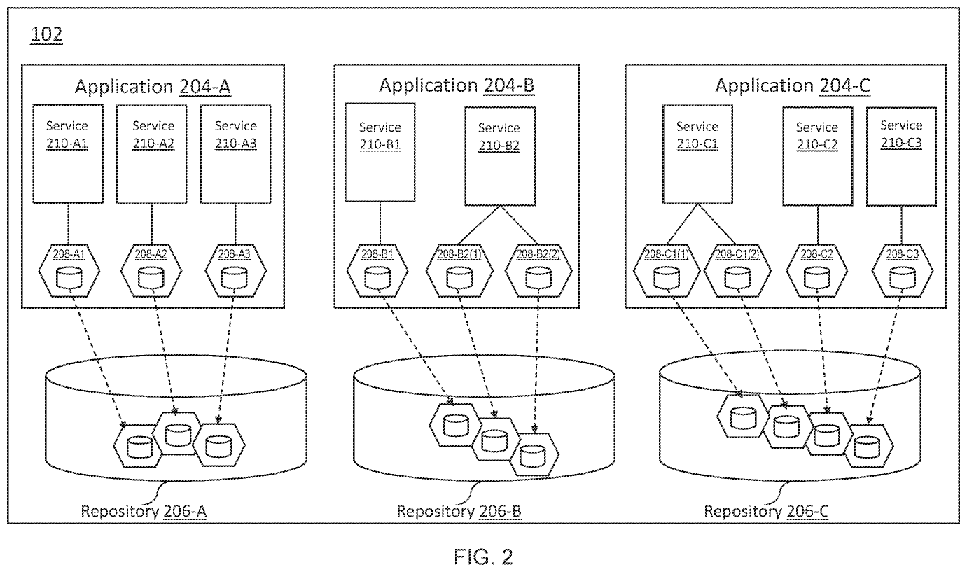

FIG. 2 illustrates a block diagram of an example data processing system 102, according to some embodiments. It is noted, however, data processing system 102 is provided solely for illustrative purposes, and is not limiting. Embodiments of this disclosure may be implemented using and/or may be part of system different from and/or in addition to data processing system 102, as will be appreciated by persons skilled in the relevant art(s) based on the teachings contained herein. An example of data processing system 102 shall now be described.

In some aspects, data processing system 102 may contain one or more applications 204 (e.g., 204-A, 204-B, 204-C, . . . , 204-X . . . ). One or more applications 204 may include software applications that are configured to execute on data processing system 102 (e.g., a computer system or a virtual machine operating on a computer system) and be accessed, controlled, managed, etc. via the client device 101. In some aspects, the one or more applications 204 may include server applications and/or mid-tier applications (e.g., HTTP (hypertext transport protocol) server applications, FTP (file transfer protocol) server applications, CGI (common gateway interface) server applications, Java™ server applications, etc.).

In some aspects, each application 204 may be a distributed application comprising services 210 (e.g., 210-A1, 210-A2, 210-A3, . . . , 210-X1 . . . ), including for example, a microservice. Each service 210 may have several service instances 208 (208-A1, 208-A2, 208-A3, . . . , 208-X1(1), 208-X1(2), . . . ). In some aspects, data processing system 102 may be cluster managed by a cluster orchestrator. Data processing system 102 may simultaneously host and run multiple applications 204. The set of applications 204 in data processing system 102 can be dynamic, in which the composition of each application 204 may change over time (e.g., due to upgrades) and the set of applications 204 themselves may also change over time.

In some aspects, services 210 may include software components, modules, application, etc. that are configured to execute on data processing system 102 and provide functionalities to the client device 101 via the networks 110 Services 210 may be web-based services or on-demand cloud services.

In order to store the underlying data in a cloud orchestrator, data processing system 102 can use a per-application repository 206 (e.g., 206-A, 206-B, 206-C, . . . 206-X, . . . ). Data processing system 102 can store the data from all the service instances 208 in a single repository 206, such as an object store bucket. Data in a service instance 208 may all belong to the same application 204, and data from different applications 204 may be stored in separate repositories 206. The data may be located in separate service instances 208 each with their own access restrictions.

FIG. 3 illustrates a block diagram of an example SPQR, according to some embodiments. It is noted, however, SPQR 300 is provided solely for illustrative purposes, and is not limiting. Embodiments of this disclosure may be implemented using and/or may be part of system different from and/or in addition to SPQR 300, as will be appreciated by persons skilled in the relevant art(s) based on the teachings contained herein. SPQR 300 may be described associated with SPQR 116 and/or SPQR 118 in FIG. 1. An example of SPQR 300 shall now be described.

SPQR 300 may include a quantum computing portion 310 and a classic computing portion 320. Quantum computing portion 310 may include a memory 301, a control system 302, and a quantum processor 306. SPQR 300, quantum computing portion 310 and/or classic computing portion 320 may include less, additional or different features, and the components may be arranged differently from the arrangement described herein. SPQR 300 may include a SPQR, such as a quantum computer with a quantum hardware or a quantum-inspired device with a specialized hardware.

In some aspects, quantum computing portion 310 may be based on a quantum architecture, such as, a quantum gate system and/or a quantum annealing system. For example, a quantum gate system may perform computations using quantum gates and quantum bits that can be in a superposition of 0 and 1 states. In some examples, quantum processor 306 may include one or more qubit devices, qudit devices and/or qutrit devices. The one or more qubit devices, including for example, fixed-frequency qubit devices, and/or tunable qubit devices. In some examples, the one or more qubit devices may include a resonator device, a coupler device, or other types of devices or components.

In some aspects, all or part of quantum processor 306 may function as a quantum processor, a quantum memory, or another type of subsystem. In some examples, quantum processor 306 may include a quantum circuit system. The quantum circuit system may include qubit devices, qudit devices, qutrit devices, resonator devices, and possibly other devices that are used to store and process quantum information. In some examples, quantum processor 306 may include a superconducting circuit, and/or the qubit devices may be implemented as circuit devices that include Josephson junctions, for example, in superconducting quantum interference device (SQUID) loops or other arrangements, and may be controlled by radio-frequency signals, microwave signals, and bias signals delivered to quantum processor 306. In some examples, quantum processor 306 may include an ion trap system, and the qubit devices may be implemented as trapped ions controlled by optical signals delivered to quantum processor 306 may include. In some examples, quantum processor 306 may include a spin system, and the qubit devices may be implemented as nuclear or electron spins controlled by microwave or radio-frequency signals delivered to quantum processor 306. Quantum processor 306 may be implemented based on another physical modality of quantum computing.

In some aspects, quantum computing portion 310 may be based on a non-quantum architecture, such as, an Ising machine system, to map a problem to a mathematical model of interacting magnets, then to search for solutions specialized for combinatorial optimization problems. Ising machine system may include an annealing system and/or a laser network system.

In some aspects, quantum processor 306 may include a quantum-inspired processor, to map a problem to be solved into natural phenomena at a first step. Then the convergence properties of natural phenomena may be activated. Finally, a status may reach a convergence point The result may be observed as its solution of the problem. Quantum processor 306 may not solve problems step by step as preformed in a classic computer, and therefore, the calculation speed may not be limited by the processor's operating speed.

In some examples, in an annealing system, quantum processor 306 may map a problem, such as, a combinatorial optimization problem into an Ising model to express the behavior of magnetic spins, and receive the approximation solution by its ground-state search of the Ising model energy function. In some examples, quantum processor 306 may include one or more circuits, such as including Complementary metal-oxide-semiconductor (CMOS) circuits, static random access memory (SRAM) and/or digital circuits, to emulate the operations of the Ising model.

In some examples, in a laser network system, quantum processor 306 may include one or more optical processors. The one or more optical processors may include one or more optical devices, such as for example, optical parametric oscillators, and fiber-ring cavities. Quantum processor 306 may be associated with electronic feedbacks, such as from one or more circuits.

In some aspects, memory 301 may store program instructions that can be accessed by control system 302. In some aspects, memory 301 may store one or more quantum operations to be executed by quantum processor 306. The one or more quantum operations may include a pre-loaded non-modifiable program. The one or more quantum operations may be pre-loaded by using a template file. The template file may be created or written to indicate information, such as metadata, and/or how to process function calls with parameters associated with the one or more quantum operations.

In some aspects, the one or more quantum operations may include an operation name and/or input parameters to perform one or more quantum functions. The one or more quantum operations may be performed differently from the classic computer program. For example, the one or more quantum operations may be performed by setting the input parameters without the need of programming. In some aspects, memory 301 may include a quantum memory, realized by a same type or different types of SPQRs. In some aspects, memory 301 may include, for example, superconducting circuits, trap ions, optical lattices, quantum dots, and/or linear optics. In some aspects, memory 301 may include a classic memory.

In some aspects, control signals may be executed on the quantum processor 306 by control system 302. In some aspects, control system 302 may include a signal system that includes signal generation and/or connection hardware elements, to interface with quantum processor 306. For example, the signal system can include signal lines, signal processing hardware, filters, feedthrough devices (e.g., light-tight feedthroughs, etc.), and/or other types of components.

Classic computing portion 320 may include a memory 322 and processor 324. In some aspects, processor 324 may include a classic processor. Memory 322 may include a classic memory.

In some aspects, memory 322 may store one or more computer programs that can be executed by processor 324. The one or more computer programs may include a processing agent. In some examples, the processing agent may provide metadata associated with a quantum operation in memory 301 to one or more computing systems, such as for example, data processing system 102. The metadata may be associated with metadata about quantum operations that can be performed on quantum computing portion 310. Alternatively or in addition, the metadata may be associated with metadata about quantum operations that can be performed on one or more SPQRs (e.g., all available SPQRs) other than SPQR 300. Additional or new quantum operations may be added to quantum computing portion 310 when hardware and/or software is upgraded associated with quantum computing portion 310. The processing agent may receive a request from data processing system 102 to perform a quantum operation by quantum computing portion 310. The processing agent may receive input parameters associated with the quantum operation. The processing agent may convert the received request into a quantum operation that can be executed on by quantum computing portion 310. The processing agent may transmit the results of the quantum operation after execution back to data processing system 102.

In some aspects, memory 301 and memory 302 may be combined as one memory, such as a shared memory. Memory 301 and memory 302 may be include less, additional or different features, and may be arranged differently from the arrangement described herein.

In some aspects, SPQR 300, quantum computing portion 310 and/or classic computing portion 320 may include additional or different features, such as one or more input/output interfaces, communication or network interfaces, which are illustrated in FIG. 3.

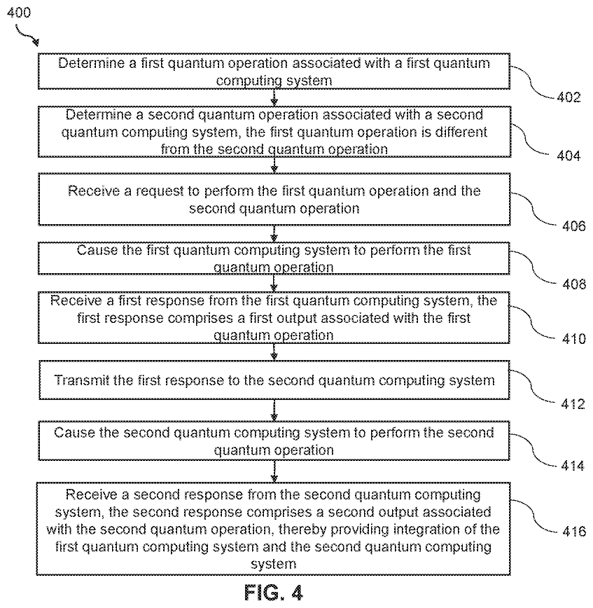

FIG. 4 illustrates an example method for providing integration of SPQRs, according to some embodiments. As a convenience and not a limitation, FIG. 4 may be described with regard to elements of FIGS. 1-3. Method 400 may represent the operation of a computing system (e.g., data processing system 102 of FIGS. 1 and 2) for providing integration of SPQRs. But method 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

In 402, data processing system 102 determines a first quantum operation associated with a first SPQR. According to some aspects, prior to the determining the first quantum operation, data processing system 102 may receive first metadata from a first computer program on the first SPQR. According to some aspects, data processing system 102 may determine the first quantum operation that can be performed by the first SPQR based at least on the first metadata. In some examples, data processing system 102 may receive first metadata from a first processing agent installed on the first SPQR that provides metadata about quantum operations that can be performed on the first SPQR.

According to some aspects, the first metadata may include an operation name and one or more input parameters associated with the first quantum operation. The first processing agent may receive first metadata from template files in the first SPQR. New or additional quantum operations can be added when hardware and/or software is upgraded on the first SPQR. In some examples, data processing system 102 may receive first metadata from a processing agent installed on one or more other SPQRs that provides metadata about quantum operations that can be performed on the first SPQR. For example, the processing agent installed on the one or more other SPQRs may communicate with the first processing agent to provide the first metadata.

In 404, data processing system 102 determines a second quantum operation associated with a second SPQR. The first quantum operation may be different from the second quantum operation. According to some aspects, prior to the determining the second quantum operation, data processing system 102 may receive second metadata from a second computer program on the second SPQR. According to some aspects, data processing system 102 may determine the second quantum operation that can be performed by the second SPQR based at least on the second metadata.

According to some aspects, data processing system 102 may receive second metadata from a second processing agent installed on the second SPQR that provides metadata about quantum operations that can be performed on the second SPQR. In some examples, the second metadata may include an operation name and one or more input parameters associated with the second quantum operation. The second processing agent may receive second metadata from template files in the second SPQR. New or additional quantum operations can be added when hardware and/or software is upgraded on the second SPQR In some examples, data processing system 102 may receive second metadata from a processing agent installed on one or more other SPQRs that provides metadata about quantum operations that can be performed on the second SPQR. For example, the processing agent installed on the one or more other SPQRs may communicate with the second processing agent to provide the second metadata.

According to some aspects, the first SPQR or the second SPQR may include SPQR 300 described with reference to FIG. 3. In some examples, the first SPQR or the second SPQR may include a quantum computer with a quantum hardware or a quantum-inspired device with a specialized hardware. In some examples, the first SPQR and the second SPQR may be different types to perform different types of quantum operations. For example, the first SPQR may include a quantum-inspired annealing systems, such as a Digital Annealer The second SPQR may include a NISQ computer.

According to some aspects, the first quantum operation may be incompatible with the second SPQR. The second quantum operation may be incompatible with the first SPQR. In some examples, the first SPQR may not be able to perform the second quantum operation. The second SPQR may not be able to perform the first quantum operation.

According to some aspects, the first quantum operation may include a first set of quantum operations. For example, the first set of quantum operations may include a third quantum operation, a fourth quantum operation and/or a sixth quantum operation. According to some aspects, the second quantum operation may include a second set of quantum operations. For example, the second set of quantum operations may include the third quantum operation, the fourth quantum operation and/or a seventh quantum operation. In some examples, the seventh quantum operation may be different from the sixth quantum operation.

In 406, data processing system 102 receives a request to perform the first quantum operation and the second quantum operation. According to some aspects, data processing system 102 may receive the request from a client device (e.g., client device 101) and/or one or more computing systems (e.g., a classic computing system). In some examples, data processing system 102 may receive the request to read information from different sources, for example, from a database, or XML files associated with one or more data storage systems 104, and call operations on the first SPQR and/or the second SPQR. In some examples, data processing system 102 may provide one or more capabilities of the first SPQR and/or the second SPQR to the client device (e.g., client device 101) and/or one or more computing systems. Thee one or more capabilities may include capabilities to perform the first quantum operation the first SPQR and capabilities to perform the second quantum operation using the second SPQR. In some examples, the request may include the request to perform the first quantum operation using the first SPQR and perform the second quantum operation using the second quantum operation. In some examples, data processing system 102 may generate one or more quantum functions to perform the first quantum operation and/or the second quantum operation.

In 408, data processing system 102 causes the first SPQR to perform the first quantum operation. According to some aspects, data processing system 102 may transmit, to the first computer program, a first request to perform the first quantum operation using the first SPQR. In some examples, the first request may include a first identifier associated with the first quantum operation (e.g., operation name) and at least one first input parameter in the request.

In 410, data processing system 102 receives a first response from the first SPQR. According to some aspects, the first response may include a first output associated with the first quantum operation. In some examples, data processing system 102 may receive the first response from the first computer program.

In 412, data processing system 102 transmits the first response to the second SPQR. According to some aspects, data processing system 102 may transmit to the second computer program, a second request to perform the second quantum operation using the second SPQR In some examples, the second request may include a second identifier associated with the second quantum operation and at least one second input parameter associated with the first response from the first SPQR.

In 414, data processing system 102 causes the second SPQR to perform the second quantum operation.

In 416, data processing system 102 receives a second response from the second SPQR, thereby providing integration of the first SPQR and the second SPQR. In some examples, the second response may include a second output associated with the second quantum operation. In some examples, data processing system 102 may receive the second response from the second computer program.

According to some aspects, data processing system 102 may transmit the second response to the client device and/or one or more computing systems, to provide a response to the request. Alternatively or in addition, data processing system 102 may transmit the second response to one or more other SPQRs, for example a third SPQR to perform third quantum operation, prior to provide a response to the request.

According to some aspects, data processing system 102 and/or one or more collecting systems may provide integration of multiple SPQRs to achieve quantum distributed processing. In some examples, a same type of SPQRs may be used in parallel processing to achieve quantum distributed processing with distributed and/or global error correction.

In some aspects, as described above with reference to FIG. 2, data processing system 102 may include a distributed application comprising services, and each service may have several service instances. In some aspects, multiple SPQRs, such as SPQR 116 and/or SPQR 118, may include the same type of SPQRs. In some aspects, the same type of SPQRs may include similar quantum computer architectures, and/or mathematics and physics associated with quantum principles associated with each SPQR.

In some aspects, as described above, data processing system 102 may determine a first quantum operation associated with a first SPQR. Data processing system 102 may determine a second quantum operation associated with a second SPQR. The first SPQR and the second SPQR may be the same type of SPQR. Data processing system 102 may determine one or more quantum operations associated with one or more other SPQRs of the same type.

In some aspects, data processing system 102 may cause multiple SPQRs of the same type to perform one or more quantum operations associated with a request to perform a task. In some aspects, each of the one or more quantum operations may be associated with a different part of the request.

For example, data processing system 102 may receive a request to perform the first quantum operation associated with a first part of the request (e.g., a first request) and the second quantum operation associated with a second part of the request (e.g., a second request). In some aspects, data processing system 102 may cause the first SPQR to perform the first quantum operation while causing the second SPQR to perform the second quantum operation concurrently.

According to some aspects, as described above, data processing system 102 may transmit, to the first computer program, the first request to perform the first quantum operation using the first SPQR. In some examples, the first request may include a first identifier associated with the first quantum operation (e.g., operation name) and at least one first input parameter. According to some aspects, data processing system 102 may transmit to the second computer program, the second request to perform the second quantum operation using the second SPQR. In some examples, the second request may include a second identifier associated with the second quantum operation and at least one second input parameter.

In some aspects, a first collecting system, including for example, a SPQR or a classic computing system (e.g., data processing system 102), may collect and/or combine the outputs from the multiple SPQRs of the same type to generate a first combined output. For example, the first collecting system may receive a first output associated with the first quantum operation from the first SPQR and/or a second output associated with the second quantum operation from the second SPQR.

In some aspects, the first collecting system may transmit the first combined output to one or more computing systems (e.g., data processing system 102). The first collecting system or data processing system 102 transmit the first combined output to a client device or one or more computing systems to provide a response to the request.

Alternatively or in addition, the first collecting system may transmit the first combined output to multiple SPQRs of the same type for further or additional processing. The first collecting system may cause multiple SPQRs to perform one or more quantum operations associated with one or more remaining or different parts of the request. The one or more remaining or different parts of the request may include a third part, a fourth part, a fifth part, or any number of parts. In some aspects, whether there is one or more remaining or different parts of the request may be determined by one or more computing systems (e.g., data processing system 102). Based on the determination that there is one or more remaining or different parts of the request to be completed, the first collecting system may cause multiple SPQRs of the same type to perform one or more quantum operations associated with one or more remaining or different parts of the request.

For example, the first collecting system may cause a third SPQR to perform a third quantum operation associated with the third part of the request; while causing a fourth SPQR to perform the fourth quantum operation with the fourth part of the request concurrently. In some aspects, the second collecting system may receive a third output associated with the third quantum operation and/or a fourth output associated with the fourth quantum operation.

According to some aspects, a second collecting system may collect and/or combine outputs from the multiple SPQRs associated with the one or more remaining or different parts of the request associated with the one or more remaining or different parts of the request. The second collecting system may generate a second combined output based on the collected and/or combined outputs.

In some aspects, the second collecting system may transmit the second combined output to one or more computing systems (e.g., data processing system 102). The second collecting system or data processing system 102 transmit the second combined output to a client device or one or more computing systems to provide a response to the request.

Alternatively or in addition, the second collecting system may transmit the second combined output to multiple SPQRs of the same type to perform one or more quantum operations associated with one or more remaining or different parts of the request for further or additional processing.

In some aspects, whether there is one or more remaining or different parts of the request may be determined by one or more computing systems (e.g., data processing system 102). Based on the determination that there is one or more remaining or different parts of the request to be completed, the second collecting system may cause multiple SPQRs of the same type to perform one or more quantum operations associated with one or more remaining or different parts of the request.

In some aspects, the number of collecting systems may not be limited to two, and may include three, four, or more collecting systems, based on the determination that there is one or more remaining or different parts of the request to be completed.

Various embodiments may be implemented, for example, using one or more well-known computer systems, such as computer system 500 shown in FIG. 5. For example, data processing system 102 may be implemented using combinations or sub-combinations of computer system 500. Also or alternatively, client device 101 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for providing integration of Special Purpose Quantum Resources (SPQRs), the computer-implemented method comprising:
determining, by a computing system, a first quantum operation associated with a first SPQR;
determining a second quantum operation associated with a second SPQR, wherein the first quantum operation is different from the second quantum operation;
receiving a request to perform the first quantum operation and the second quantum operation;
causing the first SPQR to perform the first quantum operation;
receiving a first response from the first SPQR, wherein the first response comprises a first output associated with the first quantum operation;
transmitting the first response to the second SPQR;
causing the second SPQR to perform the second quantum operation; and
receiving a second response from the second SPQR, wherein the second response comprises a second output associated with the second quantum operation, thereby providing integration of the first SPQR and the second SPQR.

2. The computer-implemented method of claim 1, further comprising:
prior to the determining the first quantum operation, receiving first metadata from a first computer program on the first SPQR; and
wherein the determining the first quantum operation associated with the first SPQR comprises determining the first quantum operation associated with the first SPQR based at least on the first metadata.

3. The computer-implemented method of claim 2, further comprising:
transmitting, to the first computer program, a first request to perform the first quantum operation using the first SPQR, wherein the first request comprises a first identifier associated with the first quantum operation and at least one first input parameter in the request; and
wherein the receiving the first response from the first SPQR comprises receiving the first response from the first computer program.

4. The computer-implemented method of claim 1, further comprising:
prior to the determining the second quantum operation, receiving second metadata from a second computer program on the second SPQR; and wherein the determining the second quantum operation associated with the second SPQR comprises determining the second quantum operation associated with the second SPQR based at least on the second metadata.

5. The computer-implemented method of claim 4, further comprising:
transmitting, to the second computer program, a second request to perform the second quantum operation using the second SPQR, wherein the second request comprises a second identifier associated with the second quantum operation and at least one second input parameter associated with the first response from the first SPQR; and
wherein the receiving the second response from the second SPQR comprises receiving the second response from the second computer program.

6. The computer-implemented method of claim 1, wherein the first SPQR or the second SPQR comprises a quantum computer with a quantum hardware or a quantum-inspired device with a specialized hardware.

7. The computer-implemented method of claim 1, wherein the first quantum operation is incompatible with the second SPQR or the second quantum operation is incompatible with the first SPQR.

8. A computing system for providing integration of Special Purpose Quantum Resources (SPQRs), comprising:
one or more memories; and
at least one processor each coupled to at least one of the memories and configured to perform operations comprising:
determining a first quantum operation associated with a first SPQR;
determining a second quantum operation associated with a second SPQR, wherein the first quantum operation is different from the second quantum operation;
receiving a request to perform the first quantum operation and the second quantum operation;
causing the first SPQR to perform the first quantum operation;
receiving a first response from the first SPQR, wherein the first response comprises a first output associated with the first quantum operation;
transmitting the first response to the second SPQR;
causing the second SPQR to perform the second quantum operation; and
receiving a second response from the second SPQR, wherein the second response comprises a second output associated with the second quantum operation, thereby providing integration of the first SPQR and the second SPQR.

9. The computing system of claim 8, the operations further comprising:
prior to the determining the first quantum operation, receiving first metadata from a first computer program on the first SPQR; and
wherein the determining the first quantum operation associated with the first SPQR comprises determining the first quantum operation associated with the first SPQR based at least on the first metadata.

10. The computing system of claim 9, the operations further comprising:
transmitting, to the first computer program, a first request to perform the first quantum operation using the first SPQR, wherein the first request comprises a first identifier associated with the first quantum operation and at least one first input parameter in the request; and
wherein the receiving the first response from the first SPQR comprises receiving the first response from the first computer program.

11. The computing system of claim 8, the operations further comprising:
prior to the determining the second quantum operation, receiving second metadata from a second computer program on the second SPQR; and
wherein the determining the second quantum operation associated with the second SPQR comprises determining the second quantum operation associated with the second SPQR based at least on the second metadata.

12. The computing system of claim 11, the operations further comprising:
transmitting, to the second computer program, a second request to perform the second quantum operation using the second SPQR, wherein the second request comprises a second identifier associated with the second quantum operation and at least one second input parameter associated with the first response from the first SPQR; and
wherein the receiving the second response from the second SPQR comprises receiving the second response from the second computer program.

13. The computing system of claim 8, wherein the first SPQR or the second SPQR comprises a quantum computer with a quantum hardware or a quantum-inspired device with a specialized hardware.

14. The computing system of claim 8, wherein the first quantum operation is incompatible with the second SPQR or the second quantum operation is incompatible with the first SPQR.

15. A non-transitory computer-readable medium having instructions stored thereon that, when executed by at least one computing device, cause the at least one computing device to perform operations comprising:
determining a first quantum operation associated with a first SPQR;
determining a second quantum operation associated with a second SPQR, wherein the first quantum operation is different from the second quantum operation;
receiving a request to perform the first quantum operation and the second quantum operation;
causing the first SPQR to perform the first quantum operation,
receiving a first response from the first SPQR, wherein the first response comprises a first output associated with the first quantum operation;
transmitting the first response to the second SPQR;
causing the second SPQR to perform the second quantum operation; and
receiving a second response from the second SPQR, wherein the second response comprises a second output associated with the second quantum operation, thereby providing integration of the first SPQR and the second SPQR.

16. The non-transitory computer-readable medium of claim 15, the operations further comprising:
prior to the determining the first quantum operation, receiving first metadata from a first computer program on the first SPQR; and
wherein the determining the first quantum operation associated with the first SPQR comprises determining the first quantum operation associated with the first SPQR based at least on the first metadata.

17. The non-transitory computer-readable medium of claim 16, the operations further comprising:
transmitting, to the first computer program, a first request to perform the first quantum operation using the first SPQR, wherein the first request comprises a first identifier associated with the first quantum operation and at least one first input parameter in the request; and
wherein the receiving the first response from the first SPQR comprises receiving the first response from the first computer program.

18. The non-transitory computer-readable medium of claim 15, the operations further comprising:
prior to the determining the second quantum operation, receiving second metadata from a second computer program on the second SPQR; and
wherein the determining the second quantum operation associated with the second SPQR comprises determining the second quantum operation associated with the second SPQR based at least on the second metadata.

19. The non-transitory computer-readable medium of claim 18, the operations further comprising:
transmitting, to the second computer program, a second request to perform the second quantum operation using the second SPQR, wherein the second request comprises a second identifier associated with the second quantum operation and at least one second input parameter associated with the first response from the first SPQR; and
wherein the receiving the second response from the second SPQR comprises receiving the second response from the second computer program.

20. The non-transitory computer-readable medium of claim 15, wherein the first SPQR or the second SPQR comprises a quantum computer with a quantum hardware or a quantum-inspired device with a specialized hardware.
